(19) United States
(12) Patent Application Publication
(10) Pub. No.: US 2004/0173408 A1
(43) Pub. Date: Sep. 9, 2004

(54) Industrial truck with a battery block located on a roller conveyor

(76) Inventors: Marek Szymanski, Kleinmeinsdorf (DE); Michael Buchmann, Glinde (DE); Stephan Ballhausen, Hamburg (DE); Torsten Gerdes, Wentorf (DE)

Correspondence Address: William H. Logsdon, WEBB ZIESENHEIM LOGSDON, ORKIN & HANSON, P.C., 700 Koppers Bldg., 436 Seventh Ave., Pittsburgh, PA, 15219-1818, US

(21) Appl. No.: 10/651,293

(22) Filed: Aug. 28, 2003

(30) Foreign Application Priority Data
Sep. 4, 2002 (DE) 102 40 854.8

(51) Int. Cl. B66F 9/06

(52) U.S. Cl. 187/222; 180/68.5

(57) ABSTRACT

An industrial truck, such as a fork lift truck, includes a battery compartment (1) and a battery block (4) which can be moved in the horizontal direction relative to the battery compartment (1). A floor of the battery compartment (1) is equipped with a roller conveyor (3). The industrial truck has at least one force-generating actuator to move the battery block (4) relative to the battery compartment (1). The actuator can have a threaded spindle (2), a pressure medium cylinder, a circulating assembly, a push chain, or a drive mechanism for the roller conveyor.

### CROSS REFERENCE TO RELATED APPLICATION

This application corresponds to German Application No. 102 40 854.8 filed Sep. 4, 2002, which is herein incorporated by reference in its entirety.

### BACKGROUND OF THE INVENTION

1. Field of the Invention

This invention relates to an industrial truck, in particular a fork lift truck, with a battery compartment having a battery block that can be moved in a horizontal direction relative to the battery compartment. The floor of the battery compartment is equipped with a roller conveyor.

2. Technical Considerations

On known industrial trucks, the battery block is located in the battery compartment and is supported on a roller conveyor located on the floor of the battery compartment. When the industrial truck is in operation, the battery block is secured to prevent it from rolling out. To change the battery block, the battery block can be pushed out of the battery compartment in a horizontal, i.e., lateral, direction relative to the industrial truck, and a new battery block can be pushed into the battery compartment in the reverse direction. For this purpose, an external roller conveyor is positioned next to the industrial truck and aligned with the roller conveyor permanently fixed to the industrial truck.

The battery block is conventionally pushed along the roller conveyors by muscle power. While the relatively lightweight battery blocks on smaller industrial trucks can be pushed by applying relatively little force, the heavier battery blocks on larger industrial trucks are practically impossible to push by hand. Battery changing systems that include horizontal roller conveyors are, therefore, uncommon on large industrial trucks. Changing the battery can also be difficult on small industrial trucks if the industrial truck is not horizontal, i.e., parked on level ground, and the battery block must, therefore, be pushed or pulled diagonally upwardly.

Therefore, it is an object of the invention to provide an industrial truck of the general type described above but in which a battery can be changed without major physical effort in any situation.

### SUMMARY OF THE INVENTION

The invention teaches that an industrial truck has at least one force-generating actuator to move the battery block relative to the battery compartment. The actuator generates sufficient force to move the battery block on the roller conveyor. In one example, the force-generating actuator of the invention can be used in connection with a telescoping or folding roller conveyor on which the battery block can be moved all the way out of the industrial truck. The actuator can assist in the movement of the battery block in both directions, i.e., the removal and the insertion of a battery block into the battery compartment.

In one potential embodiment of the invention, the battery block can have a connecting element to mechanically connect the battery block with the force-generating actuator. There can be a positive connection between the connecting element and the actuator that makes it possible to transmit force in both directions, although the connection can be easily disconnected to change the battery block. The connecting element can be in the form of a driver, for example, in which the actuator is engaged by means of a suitable mating element.

In an additional possible configuration, the battery block can be placed on a sole plate, and the sole plate mechanically connected with the force-generating actuator. In this arrangement, the sole plate on which the battery block is placed can be moved by means of the actuator. Therefore, no special connecting element on the battery block is necessary.

The actuator can be active in both directions (i.e., towards and away from the battery compartment) so that it can easily support movement of the battery block in both directions. A movable part of the actuator can, therefore, be actively driven in both directions of movement.

In a further advantageous embodiment of the invention, the force-generating actuator can have a threaded spindle. The threaded spindle is thereby driven by an electric motor and transfers its control force directly to the battery block or to the sole plate on which the battery block rests.

In this case, the threaded spindle can be realized in at least three parts. This construction makes it possible to completely remove the battery block from the battery compartment when it is inserted all the way into the battery compartment, in which position it occupies the entire width of the battery compartment. The threaded spindle thereby has a stationary segment and two telescoping segments.

In an additional advantageous embodiment, the force-generating actuator can have a pressure-medium cylinder, for example a hydraulic cylinder or a pneumatic cylinder. A hydraulic cylinder can be supplied with hydraulic fluid by the hydraulic system which is already present in an industrial truck. The force produced by the pressure medium cylinder can be transmitted directly to the battery block or to the sole plate.

To guarantee the required length of the extension, the pressure medium cylinder can have at least two coaxial piston rods that can be extended in a telescoping fashion analogous to the threaded spindle.

In an additional possible embodiment of the invention, the force-generating actuator can have circulating tension means, for example a chain, a cable, or a belt. The circulating tension means can be driven by means of an electric motor. To achieve the necessary distance the battery block has to be moved, a roller or a sprocket wheel can be moved out of the battery compartment, for example on the telescoping part of a two-part roller conveyor.

In an additional possible and advantageous embodiment, the force-generating actuator can have a push chain that can transmit pressure forces. On a push chain, the chain links are designed so that they can be folded toward only one side. Therefore, when the free end of the push chain is clamped in place and the driven end of the chain is guided appropriately, it also becomes possible to transmit pressure forces.

In an additional embodiment of the invention, the force-generating actuator can have a drive for at least one roller of the roller conveyor. In this case, at least some of the rollers of the roller platform are driven. The battery block or the sole plate, regardless of its position, is in contact with at least one driven roller. The rollers can be driven by means of toothed belts and an electric motor, for example.

Regardless of the configuration of the force-generating actuator, it is beneficial if the roller conveyor is realized in two or more parts, with at least one part of the roller conveyor movable out of the battery compartment so that the battery block can be moved on the roller conveyor all the way out of the industrial truck.

### BRIEF DESCRIPTION OF THE DRAWINGS

Additional advantages and features of the invention are explained in greater detail below with reference to the exemplary embodiments illustrated in the accompanying schematic figures, in which like reference symbols identify like parts throughout:

FIG. 1 shows a battery compartment of an industrial truck with a force-generating actuator having a threaded spindle;

FIG. 2 shows a battery compartment of an industrial truck with a force-generating actuator having a pressure medium cylinder;

FIG. 3 shows a battery compartment of an industrial truck with a force-generating actuator having circulating tension means; and

FIG. 4 shows a battery compartment of an industrial truck with a force-generating actuator having a push chain.

### DESCRIPTION OF THE PREFERRED EMBODIMENTS

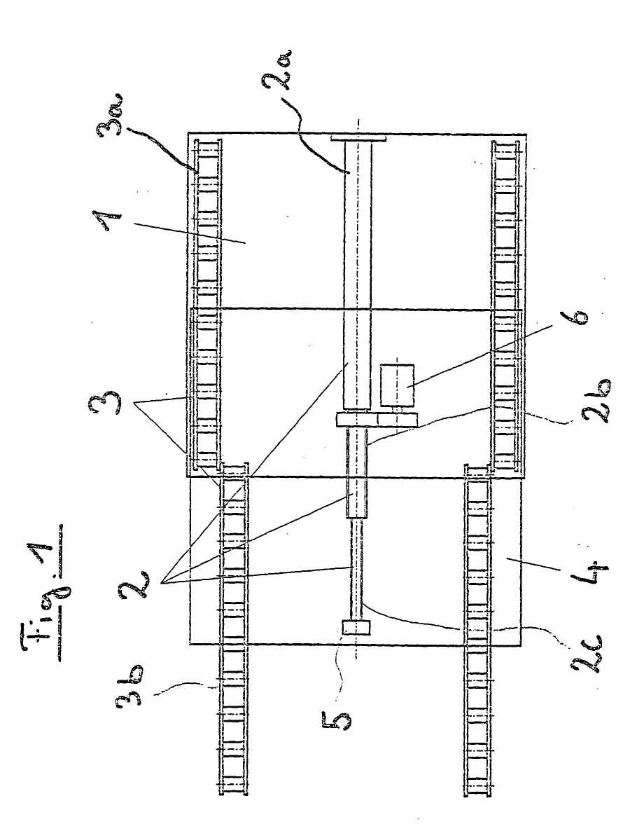

FIG. 1 shows an industrial truck battery compartment 1 with a force-generating actuator that has a threaded spindle 2. The battery compartment 1 is equipped with a roller conveyor 3 which has a fixed part 3a located in the battery compartment 1 and a second or movable part 3b that can be extended out of the battery compartment 1. A battery block 4 to supply electrical power to the industrial truck is shown on the roller conveyor 3 in a position in which it is extracted halfway out of the battery compartment 1. The threaded spindle 2 has a base or stationary part 2a fastened to the battery compartment 1, a first telescoping spindle 2b, and a second telescoping spindle 2c. The second telescoping spindle 2c can be connected with the battery block 4 via a conventional connecting element 5, such as a bolt, plate, hook, etc., so that compression and tension forces can be transmitted. The spindle 2 can be driven by any conventional means, such as an electric motor 6, the rotor of which can be connected in a torsion-proof manner with the first telescoping spindle 2b. The threaded spindle 2 can also be driven manually, for example by means of a crank that can be attached to it.

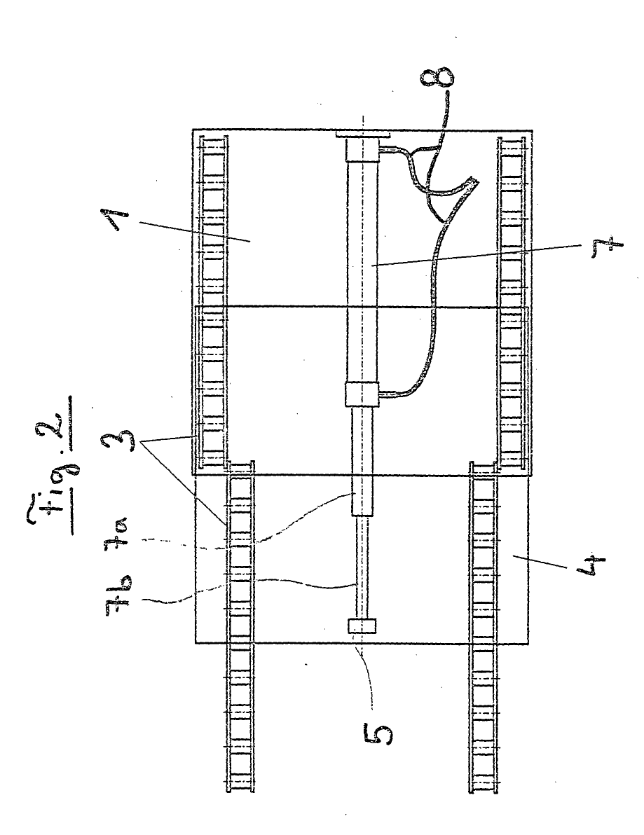

FIG. 2 shows a battery compartment 1 with a force-generating actuator that has a pressure medium cylinder. The battery compartment 1, the roller conveyor 3, and the battery block 4 are the same as in the system illustrated in FIG. 1. The actuator has a pressure medium cylinder in the form of a hydraulic cylinder 7 having two telescoping pistons 7a (first), 7b (second). The piston that can be extended the farthest (7b) can be connected with the battery block 4 by means of any conventional connecting element 5. The hydraulic cylinder 7 can be supplied with hydraulic fluid by the hydraulic work system of the industrial truck by means of hydraulic hose lines 8.

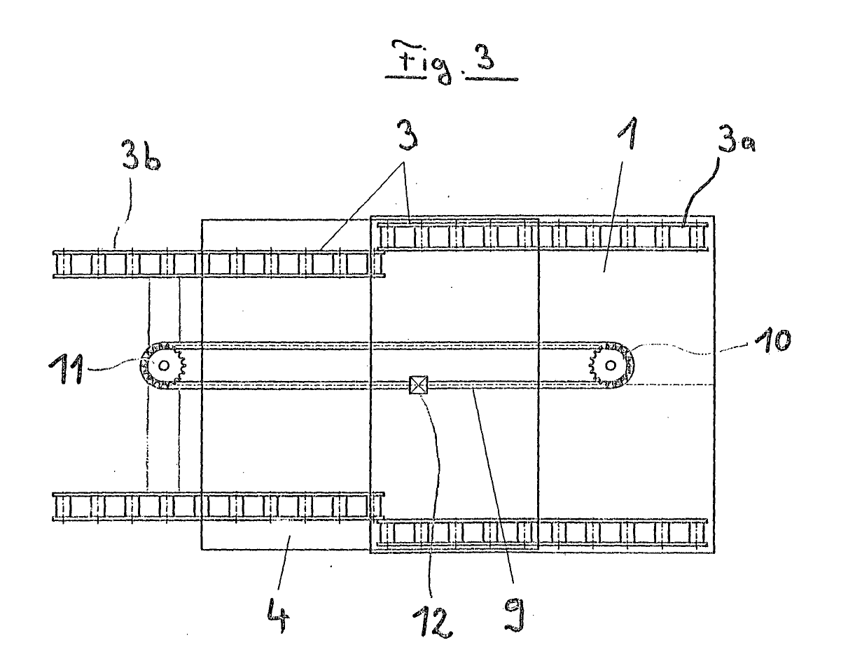

FIG. 3 shows a battery compartment 1 with a force-generating actuator that has a circulating assembly or circulating tension means 9. The battery compartment 1, the roller conveyor 3, and the battery block 4 illustrated here are also the same as in the system illustrated in FIG. 1. In the exemplary embodiment illustrated, the circulating tension means 9 can be a belt or cable or chain stretched around two sprocket wheels 10, 11. A first sprocket 10 can be mounted in a stationary manner in the battery compartment 1 and a second sprocket 11 can be mounted on the telescoping (second) part 3b of the roller conveyor 3. The tension means 9 are, therefore, placed under tension only when the roller conveyor 3 is pulled all the way out. When the roller conveyor 3 is retracted, the tension means 9, which are then not under tension, are located underneath the battery block 4. The tension means 9 are preferably driven by means of the first sprocket 10, for example by means of an electric motor located underneath the battery compartment 1. The tension means 9 are connected to the battery block 4 by means of a conventional connecting element 12.

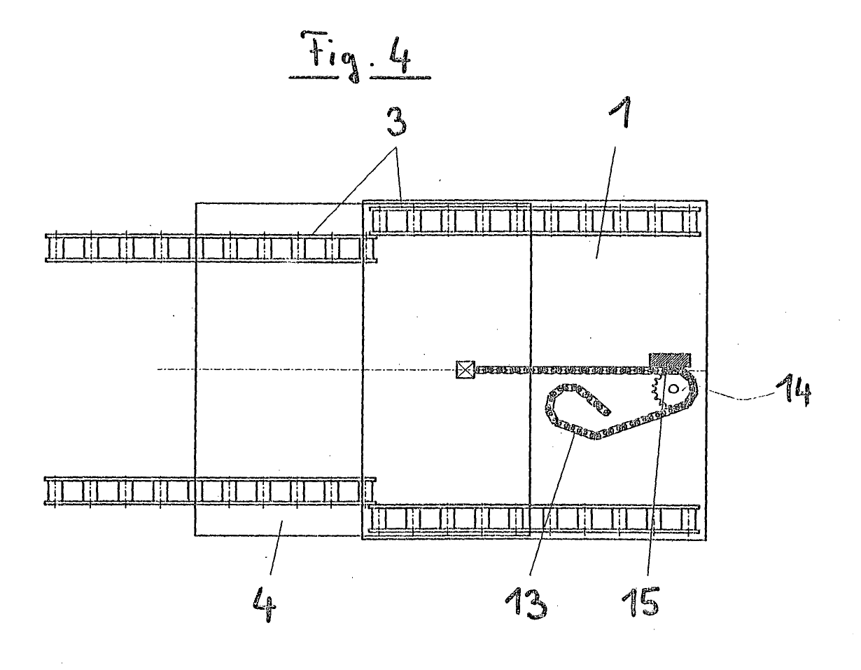

FIG. 4 shows a battery compartment with a force-generating actuator that has a push chain 13. The system comprising the battery compartment 1, the roller conveyor 3, and the battery block 4 is analogous to the system illustrated in FIG. 1. The links. in the push chain 13 are designed so that they can be folded only to one side. The push chain 13 can be driven by means of a single sprocket 14 which can be permanently fixed to the industrial truck. A guide 15 located in the vicinity of the sprocket 14 can ensure the continuous power-transmission connection between the sprocket 14 and the push chain 13. In this particular realization of the force-generating actuator, the battery block 4 sits on a sole plate which can be permanently connected to the end of the push chain 13.

In the exemplary embodiments illustrated in FIGS. 1, 2, and 3, however, the battery block 4 can also be mounted on a sole plate, and such a mounting is advantageous because the force-generating actuator can be permanently connected with the sole plate. In a system without a sole plate, a detachable connecting element can be provided for the direct connection of the force-generating actuator to the battery block 4.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An industrial truck, comprising:
a battery compartment having a floor;
a battery block movable in a lateral direction relative to the battery compartment;
a roller conveyor connected to the floor of the battery compartment; and
at least one force-generating actuator configured to move the battery block relative to the battery compartment.

2. The industrial truck as claimed in claim 1, wherein the battery block includes a connecting element for mechanical connection of the battery block with the force-generating actuator.

3. The industrial truck as claimed in claim 1, including a sole plate on which the battery block can be placed, wherein the sole plate is mechanically connected with the force-generating actuator.

4. The industrial truck as claimed in claim 1, wherein the force-generating actuator is active in directions into and out of the battery compartment.

5. The industrial truck as claimed in claim 1, wherein the force-generating actuator includes a threaded spindle.

6. The industrial truck as claimed in claim 5, wherein the threaded spindle includes at least three parts.

7. The industrial truck as claimed in claim 1, wherein the force-generating actuator includes a pressure medium cylinder.

8. The industrial truck as claimed in claim 7, wherein the pressure medium cylinder includes at least two coaxial telescoping piston rods.

9. The industrial truck as claimed in claim 1, wherein the force-generating actuator includes a circulating tension means.

10. The industrial truck as claimed in claim 1, wherein the force-generating actuator includes a push chain capable of transmitting pressure forces.

11. The industrial truck as claimed in claim 1, wherein the force-generating actuator includes a drive for at least one roller of the roller conveyor.

12. The industrial truck as claimed in claim 1, wherein the roller conveyor includes two or more parts, wherein at least one part of the roller conveyor is movable out of the battery compartment so that the battery block can be moved on the roller conveyor completely outside the industrial truck.

13. The industrial truck as claimed in claim 1, wherein the industrial truck is a fork lift truck.

14. The industrial truck as claimed in claim 7, wherein the pressure medium cylinder includes a hydraulic cylinder or a pneumatic cylinder.

15. The industrial truck as claimed in claim 9, wherein the circulating tension means includes at least one of a chain, a cable, or a belt.

16. The industrial truck as claimed in claim 3, wherein the force-generating actuator includes a threaded spindle.

17. The industrial truck as claimed in claim 3, wherein the force-generating actuator includes a pressure medium cylinder.

18. The industrial truck as claimed in claim 3, wherein the force-generating actuator includes a circulating tension means.

19. The industrial truck as claimed in claim 3, wherein the force-generating actuator includes a push chain capable of transmitting pressure forces.

20. The industrial truck as claimed in claim 3, wherein the roller conveyor includes two or more parts, wherein at least one part of the roller conveyor is movable out of the battery compartment so that the battery block can be moved on the roller conveyor completely outside the industrial truck.
